(19) United States
(12) Patent Application Publication
(10) Pub. No.: US 2016/0210807 A1
(43) Pub. Date: Jul. 21, 2016

(54) Baby Bottle Dispenser

(71) Applicants: Jonathan Michael Rosenthal, N. Reading, MA (US); Jeffrey Robert Rosenthal, Westport, CT (US)

(72) Inventors: Jonathan Michael Rosenthal, N. Reading, MA (US); Jeffrey Robert Rosenthal, Westport, CT (US); James Richardson, Eliot, ME (US)

(73) Assignees: Jonathan Michael Rosenthal, N. Reading, MA (US); Jeffrey Robert Rosenthal, Westport, CT (US)

(21) Appl. No.: 14/988,160

(22) Filed: Jan. 5, 2016

Related U.S. Application Data
(60) Provisional application No. 62/100,718, filed on Jan. 7, 2015.

(51) Int. Cl. G07F 9/10

(52) U.S. Cl. CPC G07F 9/105

(57) ABSTRACT

A baby bottle dispensing apparatus is provided that includes a refrigerator for storing a plurality of filled baby bottles, a heater external the refrigerator for heating a selected one of the plurality of filled baby bottles dispensed from the refrigerator, a conveyor for moving the selected baby bottle from the refrigerator to the heater, and a housing commonly housing the refrigerator, the heater, and the conveyor.

### CROSS-REFERENCE TO RELATED APPLICATION

This application claims the benefit of priority under 35 U.S.C. §119(e) to U.S. provisional application Ser. No. 62/100,718, filed on Jan. 7, 2015, the entire contents of which are hereby incorporated herein by reference.

### BACKGROUND

1. Field

The present application relates to baby bottle dispensing and storage devices.

2. State of the Art

Baby bottles are typically filled and stored in a refrigerator before they are needed. Such filled bottles are often warmed in a bottle warmer that is separate from the refrigerator. Thus a user who wishes to prepare a bottle for feeding a baby, usually must manually transport the prepared bottles from the refrigerator to the warmer.

In many homes, the refrigerator and warmer are located in the kitchen, which may be distant from the bedrooms and the baby's nursery. Therefore, for nighttime feedings, parents must often walk from their bedroom to the kitchen to remove a filled bottle from the refrigerator, place it in a separate warming device, wait for the bottle to reach an acceptable temperature, and walk back to their bedroom or to the baby's nursery with the warmed bottle for feeding. Also, in many cases, the baby needs a diaper change prior to feeding, which will either require an extra trip to the refrigerator and warmer or will postpone the warming process.

### SUMMARY

A baby bottle dispensing apparatus is provided that that includes a refrigerator for storing a plurality of filled baby bottles, a heater external the refrigerator for heating a selected one of the plurality of filled baby bottles dispensed from the refrigerator, a conveyor for moving the selected baby bottle from the refrigerator to the heater, and a housing commonly housing the refrigerator, the heater, and the conveyor.

A method of preparing a filled baby bottle for use includes providing the aforementioned baby bottle dispensing apparatus and receiving a signal to dispense a bottle from the dispensing apparatus. The method also includes actuating the conveyor in response to the signal to move a baby bottle from the refrigerator to the heater and heating the dispensed bottle.

The conveyor may be actuated in response to a local command at the dispenser or a remote command issued by a remote device of a user.

The dispenser may be relatively small and portable, in comparison to a household refrigerator and bottle warmer, so that the dispenser may be placed in the bedroom of a parent or in an area closer to the nursery than the kitchen.

### BRIEF DESCRIPTION OF THE DRAWINGS

FIG. 1 is an isometric view of an embodiment of a baby bottle dispenser in accordance with an aspect of the disclosure.

FIG. 2a illustrates the baby bottle dispenser of FIG. 1 filled with baby bottles, including a bottle previously transferred (or dispensed) to the bottle warmer.

FIG. 2b illustrates the baby bottle dispenser of FIG. 2a with a cover and a door frame removed for purposes of illustration.

FIG. 3 is an exploded assembly view of the baby bottle dispenser of FIG. 1.

FIGS. 4a and 4b illustrate an embodiment of an actuation unit of the dispenser shown in FIG. 3.

FIG. 5 illustrates a view of the interior of the dispenser with the cover, door frame, liner, wire rack assembly and pusher assembly of FIG. 3 removed for clarity of illustration.

FIG. 6 shows a view of the interior of the dispenser of FIG. 3 with a cover and a door frame removed for clarity of illustration.

FIG. 7 illustrates the interior of the dispenser of FIG. 6 filled with baby bottles along with a bottle dispensed to a bottle nest of the dispenser.

FIGS. 8a and 8b show a water reservoir of the dispenser shown in FIG. 3.

FIG. 9 is an exploded view of a front portion of the dispenser of FIG. 2a with the doors open and a water reservoir removed for clarity of illustration.

FIG. 10 is a detailed view of door assemblies shown in FIG. 3.

FIG. 11 illustrates a workflow for controlling the operation of the dispenser shown in FIG. 1.

### DETAILED DESCRIPTION

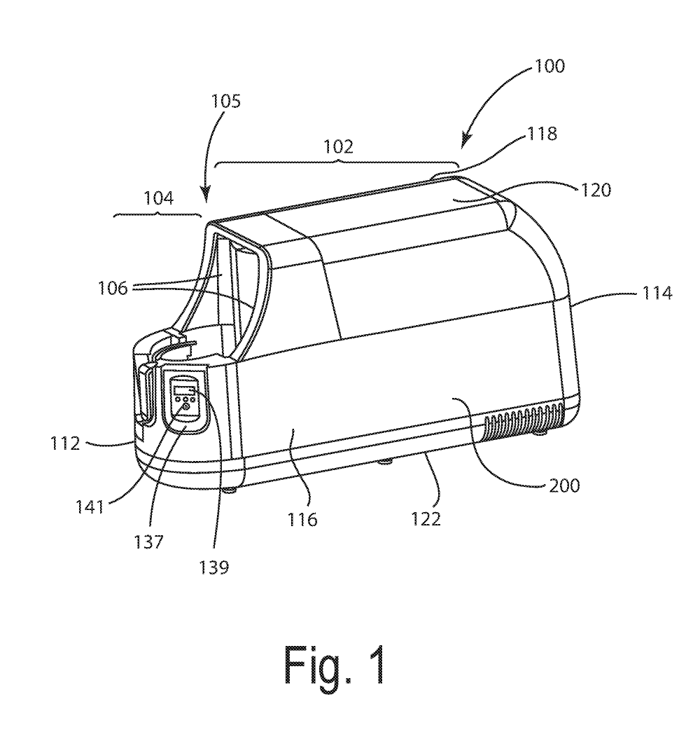

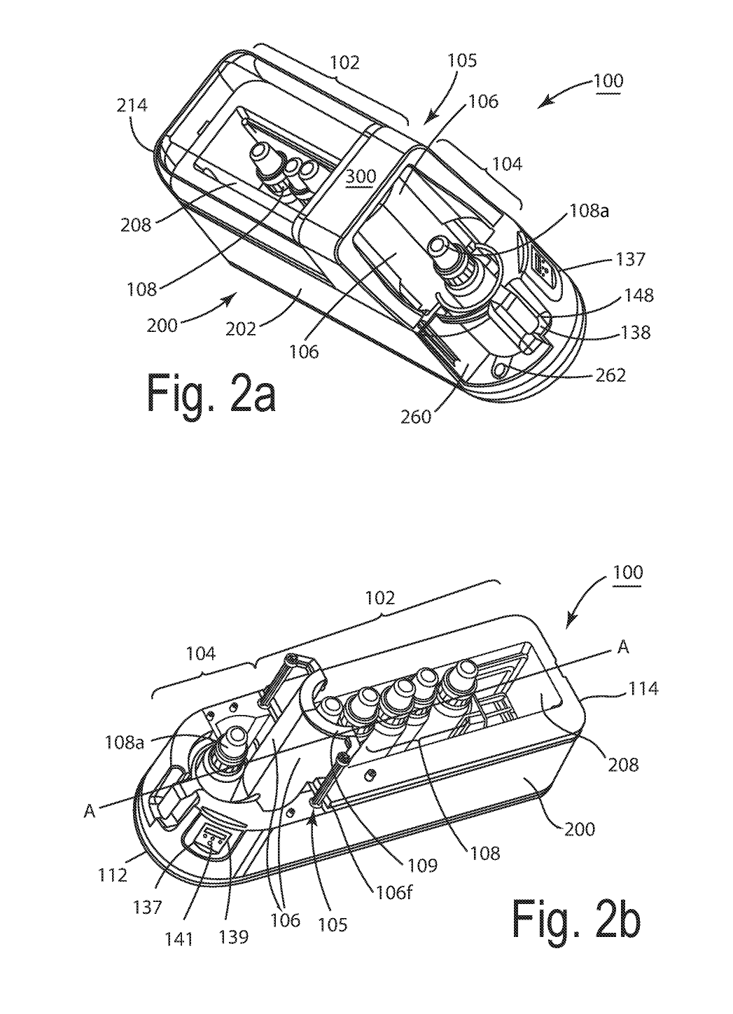

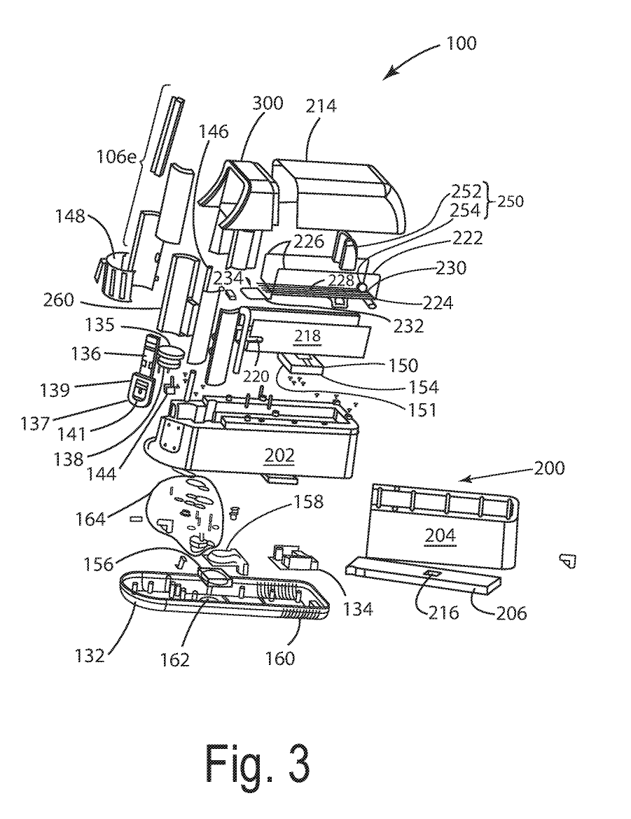

FIGS. 1, 2A, and 2B show different perspective views of an embodiment of a baby bottle dispenser 100. The dispenser 100 has a refrigerated compartment 102, a warming compartment 104, and a dispensing or conveying unit 105 all located within a common housing 200. In one embodiment, the refrigerated compartment 102 and the warming compartment 104 may be selectively separated by one or more door assemblies 106. For example, the refrigerated compartment 102 may be selectively and temporarily placed into communication with the warming compartment 104 during a dispensing operation during which a baby bottle from the refrigerated compartment 102 is conveyed by conveyor 105 to the warming compartment 104. Otherwise, when a dispensing operation is not conducted, the refrigerated compartment 102 may be separated from the warming compartment 104. To limit heat transfer into the refrigerated compartment, it will be appreciated that in at least one other embodiment, communication between the refrigerated compartment 102 and the warming compartment 104 is not necessary or may be minimized during a dispensing operation.

As shown best in FIGS. 2a and 2b, the refrigerated compartment 102 may store and refrigerate a plurality of filled baby bottles 108. As will be described in greater detail below, a conveyance arrangement 105 conveys a selected bottle 108a from the refrigerated compartment 102 to the warming compartment 104. In one embodiment the conveyance arrangement may convey the bottle 108a when the door assemblies 106 are open in order to permit a single bottle 108a to be dispensed from the refrigerated compartment 102. Otherwise, the door assemblies 106 may remain closed in order to thermally insulate the refrigerated compartment 102.

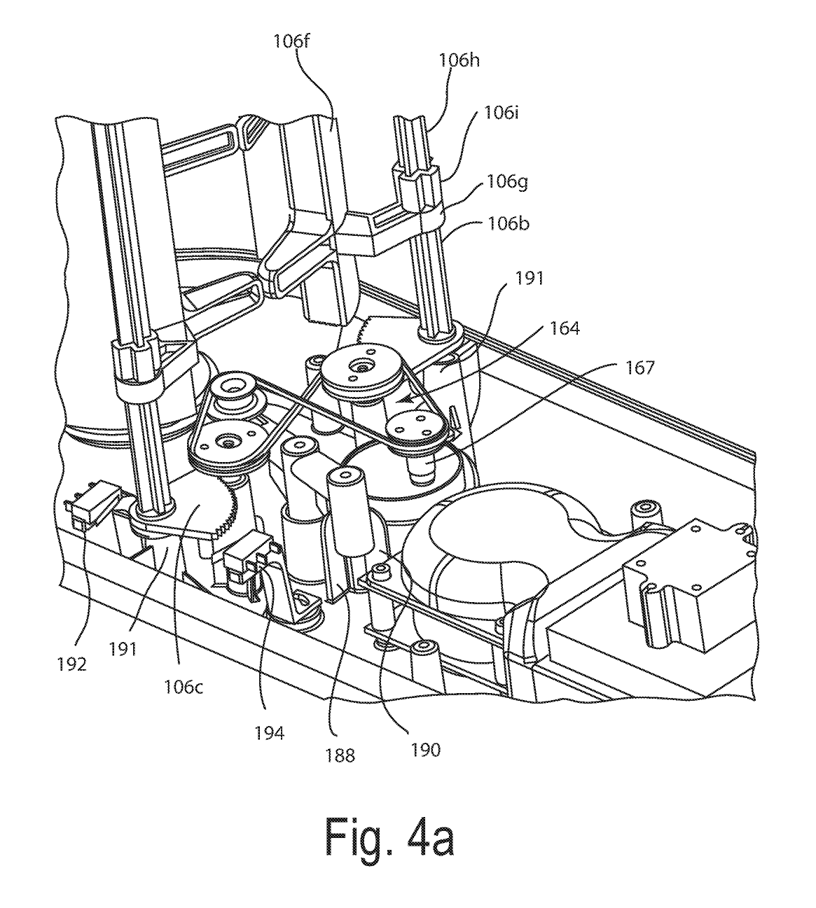

The warming compartment 104 is constructed to receive the single bottle 108a dispensed from the refrigerated compartment 102, and to warm the received bottle 108a with a heating element 138 (FIG. 2a) in the warming compartment 104. The refrigerated compartment 102, the warming compartment 104, and the conveyance arrangement may be controlled by a controller 136 (FIG. 3), which may include a control panel 137 interface as well as a wireless interface.

In general, as used herein, forward, rearward, front side, rear side, top, bottom, and left and right refer to the directions from the center of the dispenser 100. More particularly, the dispenser has a front end 112 where the warming compartment 104 is located, a rear end 114 opposite the front end, a left side 116 and a right side 118 opposite the left side 116. Also, the dispenser has a top side 120 and a bottom side 122 opposite the top side 120. In addition, a longitudinal axis A-A (FIG. 2b), which extends between the rear end 114 and the front end 112, will be referred to herein. The longitudinal axis A-A extends along the centerline of the dispenser 100, dividing the dispenser 100 into left and right sections. Thus, elements of the dispenser between the axis A-A and the right side 118 may be qualified with the term “right” and elements of the dispenser between the axis A-A and left side 116 may be qualified with the term “left”.

### Refrigerated Compartment

As noted above, the refrigerated compartment 102 may store and refrigerate a plurality of filled baby bottles 108 at a refrigeration temperature that preserves the contents of the baby bottles 108 prior to use. Thus, the refrigerated compartment 102 may be constructed to function similarly to the aforementioned household refrigerator to regulate the refrigeration temperature in the space in which the baby bottles 108 are stored and prevent spoilage of the contents of the baby bottles. Also, the refrigerated compartment 102 is configured to maintain the temperature of refrigerated bottles 108 stored in the refrigerated compartment 102 at temperatures sufficient to prevent spoliation of the contents of the baby bottles (i.e., below 40 degrees F.) for at least the suggested expiration times of the contents. For example, one article published by the The University of Nebraska Extension recommends storing bottled baby formula at a temperature below 40 degrees F. Also, some guidelines for storage of mixed baby formula of the Nemours Foundation suggest disposing of any unused mixed baby formula after 24 hours of preparation regardless of refrigeration and some guidelines for storage of opened ready-to-feed or concentrated formula suggest disposing of any unused formula after 48 hours regardless of refrigeration.

The refrigerated compartment 102 may be defined by portions of the common housing 200 (FIGS. 2a, 3). The housing 200 is preferably formed from insulated materials, such as foam and/or plastic. As shown in FIG. 3, for example, the housing 200 includes an outer shell 202, an inner shell 204 that fits within the outer shell 202 from its bottom, and a shell base plate 206 that fits within the bottom of the inner shell 204.

The refrigerated compartment 102 is constructed to be accessed by a user to, for example, replenish or remove the bottles 108 stored therein. Thus, the housing 200 includes a cover 214, which may be movable or removable with respect to the outer shell 202, to permit user access to add or remove baby bottles 108 from the refrigerated compartment 102. The cover 214 may be supported by the outer shell 202. The cover 214 may be translucent and may be partially or fully removable from the outer shell 202.

The refrigerated compartment 102 has at least one opening through which a bottle 108 stored in the refrigerated compartment 102 can be conveyed to the warming compartment 104. In the embodiment of the dispenser 100 shown in FIG. 2a, for example, the dispenser 100 includes a door frame 300 that defines an opening through which the bottle 108a can be conveyed. The door frame 300, at least in part, supports the door assemblies 106. When the door assemblies 106 are closed, as shown in FIGS. 1, 2a, and 2b, the door assemblies further define and insulate the refrigerated compartment 102.

While a specific door assembly configuration 106 is shown in FIGS. 2a and 2b, it will be appreciated that other door assembly configurations are possible, and may include one or more hinged doors, a revolving door assembly or notched disc that rotates between the refrigerated and warming compartments without opening the refrigerated compartment, or a trap (horizontal) door and chute arrangement, for example.

The stored bottles 108 in the refrigerated compartment 102 may be dispensed from the refrigerated compartment 102 one at a time from a predetermined dispensing location 109 designated in the refrigerated compartment 102. The refrigerated compartment 102 may be configured to guide the bottles 108 stored in the refrigerated compartment 102 to move towards that dispensing location. For example, as shown in FIG. 2b, the bottles 108 stand upright on their respective bottoms in a bottle storage channel 208 defined by the housing 200.

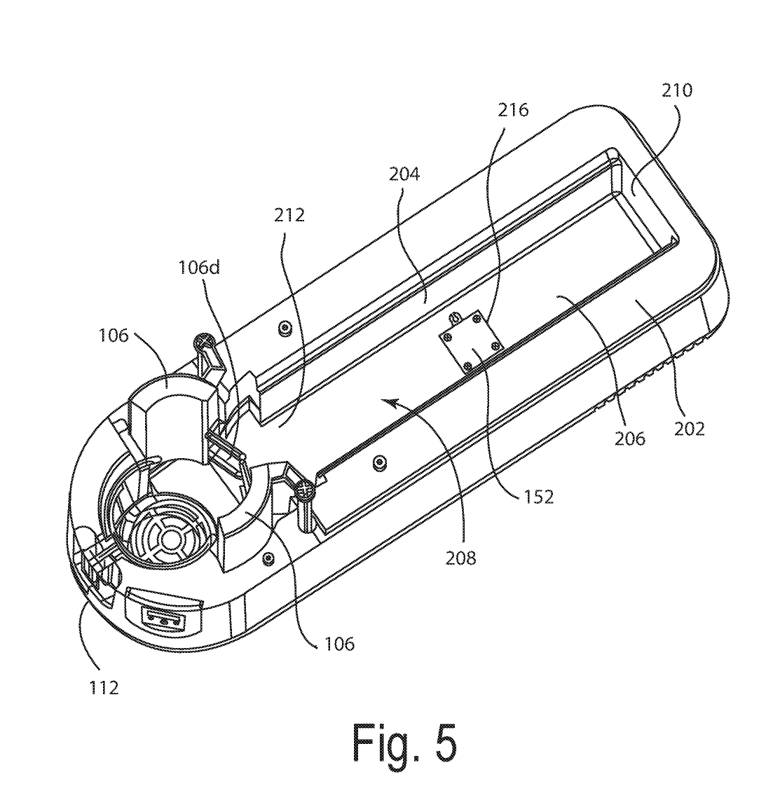

As shown in greater detail in FIG. 5, the inner shell 204 and the shell base plate 206 define the elongated bottle storage channel 208 that extends from a closed end 210 at the rear end 114 of the dispenser 100 to an open end 212 toward the front end 112 of the dispenser 100. As will be described below, the open end 212 of the bottle storage channel 208 is selectively opened and closed by the door assemblies 106.

The inner shell 204 has walls that extend upward and around the circumferential sides of the bottles 108 so that the walls restrict movement of the bottles 108 to be substantially longitudinally along axis A-A. The channel 208 guides the bottles 108 towards the dispensing location 109 just rearward of and adjacent to the closed door assemblies 106. For example, once one of the bottles 108 that is positioned at the dispensing location 109 is dispensed from the refrigerated compartment 102, the remaining bottles 108 in the refrigerated compartment 102 will move in a direction toward the dispensing location 109.

To refrigerate the refrigerated compartment 102, a cooling unit 150 (FIG. 3) is provided. The cooling unit 150 removes heat from the refrigerated compartment 102 to maintain the temperature of the refrigerated compartment 102 to prevent the contents of the bottles from spoiling before their expiration times. The cooling unit 150 may be a thermo-electric (Peltier effect) cooler that is electrically powered and controlled by the controller 136 (FIG. 3). The thermo-electric cooler 150 includes a cooling surface 152 that thermally communicates with the refrigerated compartment 102 and a heat sink 154 that extends outside of the refrigerated compartment. When the thermo-electric cooler 150 is operated, heat removed from the refrigerated compartment 102 is conducted to the heat sink 154, which may have a plurality of cooling fins 151. The heat conducted into the heat sink 154 may be removed through forced convection using an electrically powered fan 156 (e.g., a muffin-type fan) that is powered and controlled by the controller 136. An air duct 158 is connected to the fan 156 and contacts the fins 151 of the heat sink 154 to guide airflow across the fins 151 and into the fan 156. Also, inlet air vents 160 are formed in left and right sides of a bottom shell 132 of the dispenser 100 to direct cooling air through the shell 132. When the fan 156 operates, air from outside the dispenser 100 may be drawn through the inlet air vents 160 into the dispenser 100 and across the fins 151 of the heat sink 154 towards the inlet of the fan 156. After passing through the fan 156, the fan 156 exhausts the air downward through exhaust vents 162 formed in the bottom of the bottom shell 132.

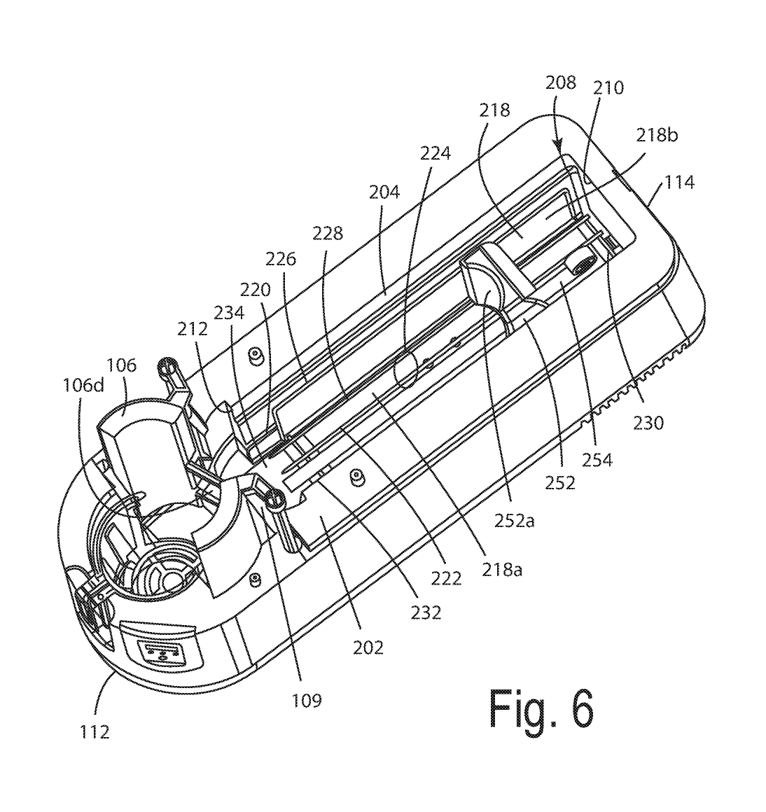

To increase the effectiveness of the thermo-electric cooler 150 and increase the surface area of a thermal conductive pathway, a metal liner 218 (FIGS. 3 and 6) may be placed into the bottle storage channel 208 so that it communicates with the cooling surface 152 (FIG. 5) of the thermo-electric cooler 150. For example, as shown more clearly in FIG. 5, the shell base plate 206 has an opening 216 that aligns with the upper surface 152 of the thermoelectric cooler 150. The upper surface 152 of the thermoelectric cooler 150 may protrude slightly into the bottle storage channel 208 or may be flush with the top surface of the shell base plate 206. The metal liner 218 is received in the bottle storage channel 208 and contacts the cooling surface 152 of the thermo-electric cooler 150. The metal liner 218 may be formed of aluminum or other metal to promote heat conduction. Owing to such contact between the liner 218 and the cooling surface 152 of the cooler 150, heat can be conducted through the liner 218 to the cooling surface 152 to more evenly distribute the heat removal from the refrigerated compartment 102 to provide a more uniform temperature throughout the refrigerated compartment 102.

As shown most clearly in FIG. 6, the liner 218 has a bottom wall 218a and opposing sidewalls 218b. The outer dimensions of the liner 218 may be the same as the inner dimensions of the bottle storage channel 208 so that the liner 218 conforms to the bottle storage channel 208. The sidewalls of the liner have slots 220 formed on a front portion thereof to receive projections 106d (e.g., FIGS. 6, 9, and 10) of the door assemblies 106 when the door assemblies 106 are closed.

To promote more even cooling within the refrigerated compartment 102, the bottoms and/or circumferential sides of the bottles 108 may be spaced from the liner 218 or from the storage channel 208 (if a liner 218 is not employed) so that there is at least some airspace around the bottles 108. To provide such spacing of the bottles 108, a wire rack assembly 222 (FIGS. 3, 6, and 7) may be interposed between the bottles 108 and either the bottle storage channel 208 or the liner 218, as the case may be.

The wire rack 222 has a base 224 (FIGS. 3 and 6) that is constructed to support the weight of the plurality of filled bottles 108. The wire rack assembly 222 has opposing side rails 226 (FIGS. 3 and 6) that extend along corresponding sidewalls 218b of the liner 218. The side rails 226 also space the circumferential sides of the bottles 108 from the liner 218. The relatively small surface area of the wire rack assembly 222 in contact with the bottles 108 may also reduce frictional forces on the bottles 108, making it easier to slide the bottles 108 toward the dispensing position 109 in the bottle storage channel 208 during a dispensing operation, described in greater detail below.

The base 224 has a wire formed section 228 that extends from a first end 230 to a second end 232. The base 224 of the wire rack assembly 222 also has a solid ramp 234 that extends forward from the second end 232 of the wire formed section 228 and beyond the open end of the channel 208. The top surface of the ramp 234 is inclined downward with respect to the wire formed section 228 to promote sliding a bottle stored on the ramp 234 towards the front 112 of the dispenser 100 to facilitate dispensing. As shown in FIG. 6, the dispensing position 109 may be located on the ramp 234.

The spacing between the side rails 226 of the wire rack assembly 222 defines a width of the wire rack assembly 222, while the length of the side rails 226 defines a length of the wire rack assembly 222. In one embodiment, the width and length of the wire rack assembly 222 are a function of the diameter of one of the baby bottles 108. In one embodiment, the width is slightly greater than the diameter of one baby bottle to accommodate the bottle, and the length is slightly greater than a multiple of the diameter of the baby bottle to accommodate a plurality of bottles. A typical diameter of a baby bottle is about 2 inches.

### Conveyance Unit

As described above, the dispenser 100 stores the bottles 108 in the refrigerated compartment 102 until they are conveyed or otherwise dispensed from the refrigerated compartment 102 for warming in the warming compartment 104. To convey the bottles from the refrigerated compartment 102 to the warming compartment 104, the dispenser 100 includes a conveyance arrangement 105 (i.e., a “conveyor”), which may include one or more assemblies, such as a pusher assembly 250 (FIG. 3) and an actuator assembly 164 (FIG. 3). In general, the conveyance arrangement functions to move a bottle 108a out of the refrigerated compartment 102 to the warming compartment 104. Also, the conveyance unit may be configured to perform its dispensing function in response to a command from the controller 136, which is initiated based on a user instruction.

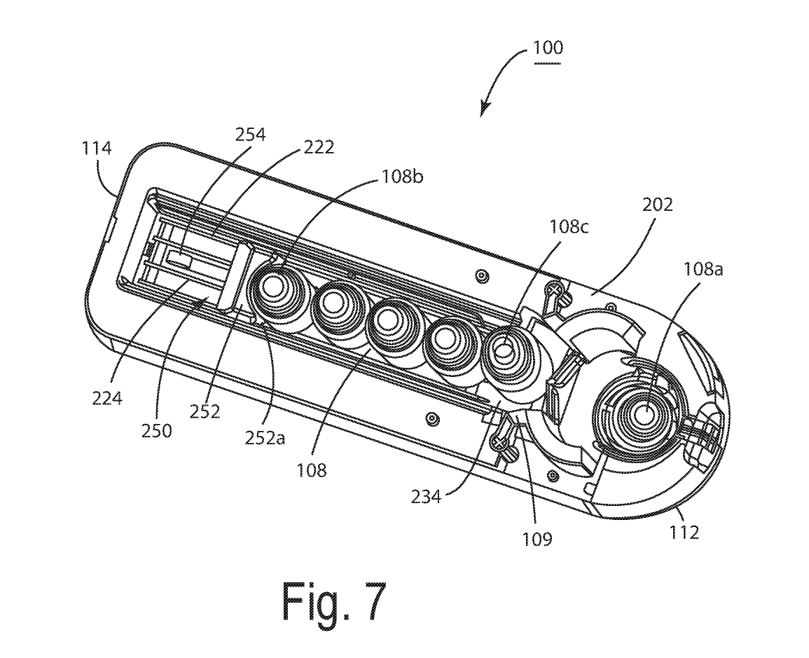

In one embodiment shown in FIG. 7, the conveyance arrangement is constructed to open the door assemblies 106, push bottle 108a through the opening between the door assemblies 106 into the warming compartment 104, and close the door assemblies 106 once the bottle 108a has been moved to the warming compartment 104.

In FIG. 7, the plurality of bottles 108 are positioned adjacent to one another within the wire rack assembly 222. A pusher assembly 250 is provided that pushes on the bottles 108 to urge them forward towards the front end 112 of the dispenser 100. The pusher assembly 250 is supported by the wire rack 222 and includes a pusher 252 and a biasing member 254. The pusher 252 has a generally concave front surface 252a that is adjacent to a rearmost bottle 108b on the wire rack 222. The pusher 252 has a bottom (not shown) that rides on the base 224 of the wire rack assembly 222. The biasing member 254 urges the pusher 252 toward the front of the dispenser 112 into contact with a portion of the circumference of bottle 108b. The biasing member 254 may be a spring that is supported by the wire rack 222. The force exerted on the pusher 252 by the biasing member 254 is transmitted to all of the bottles 108 on the wire rack 222 (as the bottles are in contact with one another) and urges them all forward against the door assemblies 106. When bottle 108a is dispensed from the rack 222, the force exerted by the pusher 252 and the biasing member 254 is sufficient to index the bottles 108 in the wire rack 222 forward toward the door assemblies 106 so that a forward-most bottle 108c in the wire rack 222 is positioned on the ramp 234 of the wire rack 222 at the dispensing position 109.

While the pusher assembly 250 is described above in conjunction with the biasing member 254, it will be appreciated that the pusher 252 may be acted on by a member that does not bias the pusher 252. For example, instead of a biasing member 254, a motor (e.g., a stepper motor) may be used to move the pusher 252 forward whenever the conveyance arrangement is operated to convey a bottle 108 from the refrigerated compartment 102 to the warming compartment 104.

As noted above, the conveyance arrangement may be configured to open the door assemblies 106 to create a temporary opening through which to convey bottle 108a through from the refrigerated compartment 102 to the warming compartment 104. As described in greater detail below, the door assemblies 106 may be opened and closed by an actuator assembly.

As shown in FIG. 3, the door assemblies 106 are supported at a bottom end by a bottom shell 132 and, at a top end, by the door frame 300, which is supported by the outer shell 202 and extends over an open end 212 of the bottle storage channel 208 and the ramp 234 of wire rack assembly 222.

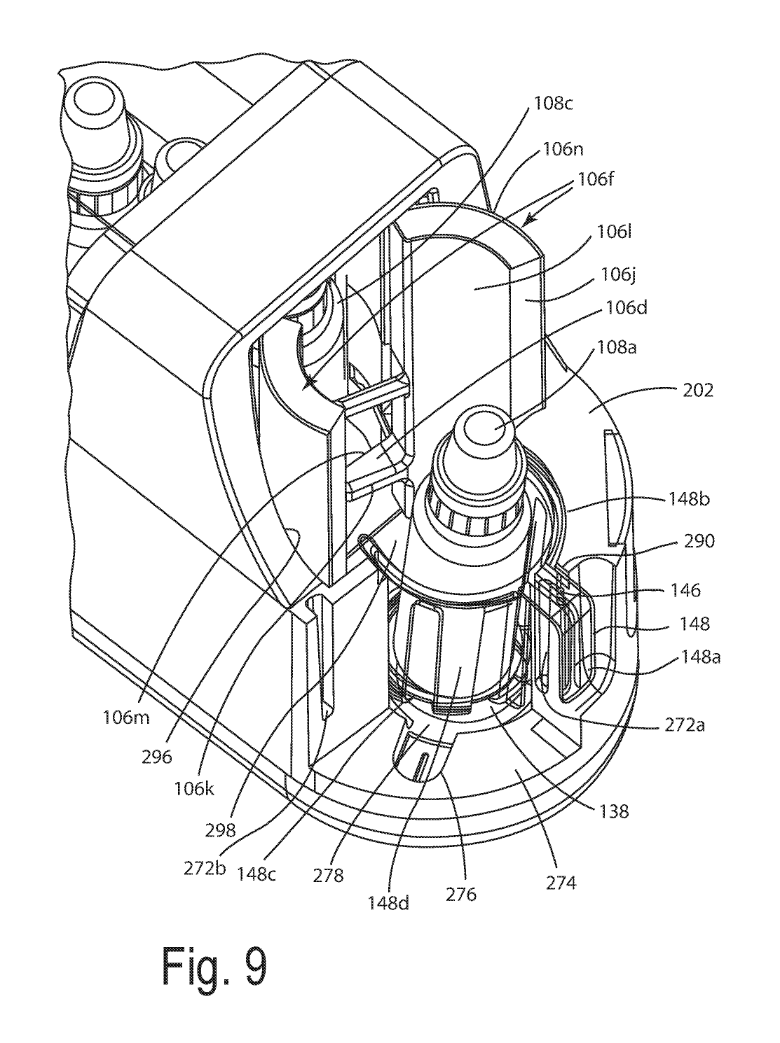

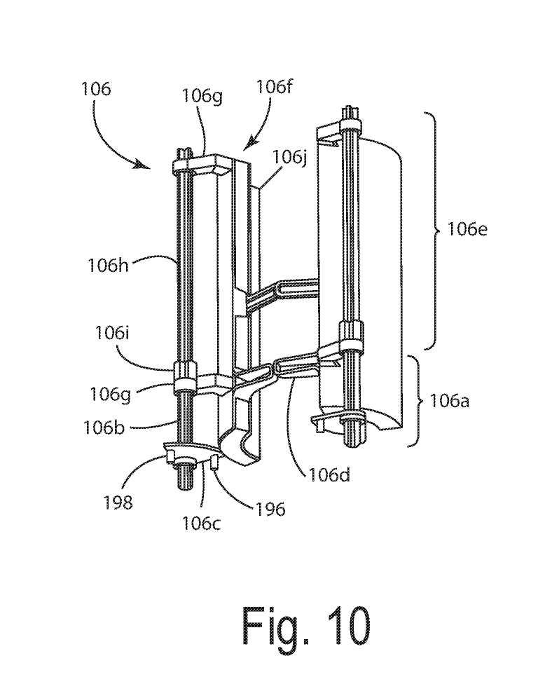

The door assemblies 106 are shown in greater detail in FIGS. 9 and 10. Each door assembly 106 includes a door panel 106f connected to one or more axle connectors 106g. Two axle connectors 106g (an upper connector and a lower connector) are shown in FIG. 10, but more or fewer axle connectors may also be employed. The upper and lower axle connectors 106g each have X-shaped openings that are aligned with one another and through which respective upper and lower axle sections 106b and 106h extend. The upper and lower axle sections 106b and 106h have X-shaped cross-sections that mate with the respective X-shaped openings of the axle connectors 106g. When each door assembly 106 is assembled, the lower axle section 106b may extend above the lower axle connector 106g, as shown in FIG. 10. The upper axle section 106h is joined to the lower axle section 106b with axle-to-axle connector 106i. The joining of the upper and lower axle sections 106h and 106b with axle-to-axle connectors 106i facilitates assembly of the door assemblies 106 of the dispenser 100 in two sections, 106a and 106e, which may be joined together during assembly of the dispenser 100.

The X-shaped openings and corresponding X-shaped cross section of the upper and lower axle sections rotationally fix the door panel 106f with respect to a gear section 106c. A left gear segment 106c is attached to the left lower door axle 106b and a right gear segment 106c is attached to the right lower door axle 106b. Each gear segment 106c has a plurality of gear teeth to operate the gear segment 106c through a predetermined angular displacement with respect to its corresponding lower door axle section 106b. Accordingly, rotation of the gear segment 106c drives rotation of the entire door assembly 106.

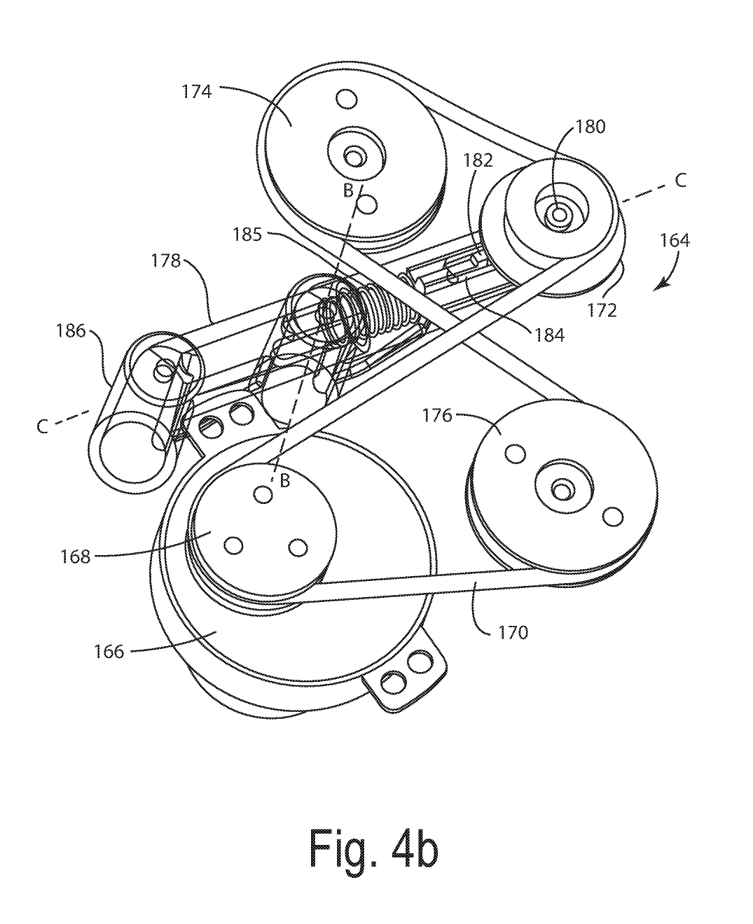

The door assemblies 106 can be arranged to rotate synchronously together or asynchronously. Thus, with each door panel 106f supported by its corresponding axle sections 106h and 106b between the door frame 300 and the bottom shell 132, the door assemblies 106 may be opened and closed simultaneously with the rotation of their respective gear sections 106c when the gear sections 106c are driven by an actuator assembly 164 (FIGS. 4a and 4b), as described in greater detail below.

Each door panel 106f may be curved on its outer side and its inner side, as shown in FIGS. 9 and 10. Each side of the door may span a 90 degree arc so that when both doors are closed together they form a semicircular surface on the inner and outer sides of the door panels 106f, such as shown in FIG. 2b. From their closed positions, the door panels 106f swing outwardly open until the door panels 106f are received in curved recesses 296 (FIG. 9) formed in the inner side walls of the outer shell 202. When both door panels 106f are received in the recesses 296, they cannot rotate any farther and are fully opened. When the doors 106 are fully opened, the distance between free ends 106j of the doors 106 is larger than the width of the wire rack 222 and, therefore, wider than the width of any bottle (e.g., bottle 108a) that may be dispensed from the dispenser 100.

The door assemblies 106 may be provided with an integral dispensing feature, such that the opening of the door assemblies 106 may effect conveyance of a bottle from the refrigerated compartment 102. For example, as shown in FIG. 9, each door panel 106f has at least one projection 106d that has a front face 106k that extends from an inner curved surface 106L of the door panel 106f and has a rear face 106m that extends from an outer curved surface 106n of the door panel 106f. The front face 106k may extend tangentially from the inner curved surface 106L. The rear face 106m may extend with respect to the outer curved surface 106n so that when the door panels 106f are fully opened and in contact with the recesses 296, the rear faces 106m are substantially perpendicular (+/−15 degrees) to the longitudinal axis A-A (FIG. 2b) of the dispenser 100.

When both door panels 106f are open, as shown in FIG. 9, force exerted by the pusher assembly 250 pushes the forward most bottle 108c against the rear faces 106m of the projections 106d. However, because the door panels 106f are fully opened and, thus, prevented from further opening by the recesses 296 in the outer shell 202, the rear faces 106m of the projections 106d to form a barrier against which the force of the pusher assembly 250 cannot push the bottle 108c through. Also, during rotation of the doors 106 from the open position to a closed position, the rear faces 106m of the projections push against bottle 108c, which is being pushed by the pusher assembly 250, until the distance between ends of the projections 106d increases sufficiently so that the bottle 108c is pushed through the projections. However, at the point at which the bottle 108c is to be pushed through the opening between the projections 106d, the opening between the free ends 106j of the door panels 106f is insufficient to allow the bottle 108c to pass to the bottle nest 148. As a result, the bottle 108c remains captured between the projections 106d and the inner surfaces 106L of the door panels 106f, while the bottle 108c remains supported on the ramp 234 of the wire rack assembly 222. When the bottle 108c is captured, it is positioned at the dispensing position.

The dispensing position 109 may be elevated with respect to the warming compartment 104 so that the force of gravity acting on a bottle 108 in the dispensing position 109 may also be used to move the bottle 108 towards the warming compartment 104. For example, the ramp 234 of the wire rack assembly 222 is spaced vertically with respect to the heating element 138. The outer shell 202 has an inclined surface 298 (FIG. 9) that extends between the door recesses 296. The inclined surface 298 facilitates sliding of the dispensed bottle 108a from the captured, dispensing position 109 on the ramp 234 to the warming compartment 104. The captured bottle 108c can be dispensed by opening the door assemblies 106, whereupon the captured bottle 108c is pushed forward by the forward faces 106k of the projections 106d, down the ramp 234 of the wire rack 222 and the inclined surface 298 of the outer shell 202, and into the warming compartment 104.

As mentioned above, the conveyance arrangement 105 may also include an actuator assembly that may trigger the dispensing of a bottle from the refrigerated compartment 102. For example, as noted above, the opening of the door assemblies 106 of dispenser 100 may cause one of the bottles 108 to be dispensed from the refrigerated compartment 102. An actuator assembly 164, shown in FIGS. 3, 4a, and 4b is provided for opening and closing the left and right door assemblies 106 of the dispenser 100 to effectuate the dispensing of bottle 108a.

The actuation assembly 164 may be constructed to open the door assemblies 106 to dispense the bottle 108a and to close the door assemblies 106 after dispensing the bottle 108a. The actuation assembly 164 may be powered and controlled by the controller 136 and may be configured to receive a door opening signal from the controller 136 to perform a dispensing operation that includes opening and closing the door assemblies 106 in a sequence in which the bottle 108a is dispensed between opening and closing of the door assemblies 106, as described in greater detail below.

As shown in greater detail in FIG. 4b, the actuator assembly 164 includes a motor 166 that is electrically powered and controlled by the controller 136. In one embodiment the motor 166 is a 12 VDC motor. The motor 166 has a shaft 167 that is connected to a drive gear 168. In the embodiment shown in FIGS. 4a and 4b, the drive gear 168 is a ball chain gear that drives a ball chain belt 170 about an idler 172, a left ball chain gear 174, and a right ball chain gear 176. The drive gear 168 drives the left and right ball chain gears 174, 176 through movement of the ball chain belt 170. The ball chain belt 170 is routed from the drive gear 168 to the idler 172, then to the left ball chain gear 174, then to the right ball chain gear 176, and back to the drive gear 168. The ball chain belt 170 crosses over at a location between the left and right ball chain gears 174, 176 to reverse the rotational direction of the left and right ball chain gears 174 and 176 with respect to one another when the belt 170 moves so that both gear sections 106c and their respective door assemblies 106 rotate in relatively opposite directions, as described in greater detail below.

Also, as shown most clearly in FIG. 4b, the idler 172 is supported on a swivel arm 178, which is pivotally connected to the bottom shell 132 about a swivel axis B-B. The idler 172 rotates on an idler hub 180 that is constructed for relative translation with the swivel arm 178 along a longitudinal axis C-C of the swivel arm 178. The swivel arm 178 houses a spring 185 that biases the idler hub 180 along axis C-C in a direction away from the swivel axis B-B. The idler hub 180 has a tab 182 that rides in a longitudinal slot 184 of the swivel arm 178. The slot 184 limits inward longitudinal translation of the idler hub 180 towards axis B-B. The idler spring exerts a force on the idler 172 to take up slack in the ball chain belt 170. Also, the idler spring relieves force on the gears 168, 174 and 176 in the event that they cannot rotate (i.e., are jammed). The swivel arm 178 has an end 186 opposite the idler 172 that rotates about the swivel axis B-B between two vertical flanges 188 and 190 (FIG. 4a) that extend from the bottom shell 132. The flanges 188 and 190 act as stops that limit the rotational movement of the swivel arm 178.

The actuator assembly 164 opens and closes the door assemblies 106, shown partially in FIG. 4a, and in greater detail in FIG. 10. The bottom shell 132 supports bottom portions 106a of the left and right door assemblies 106. The bottom shell 132 has left and right axle supports 191 to receive respective lower door axle sections 106b of the right and left door assemblies 106. The left and right ball chain gears 174 and 176 also have gear teeth that mesh with the gear teeth of the respective left and right gear segments 106c to drive those gear segments when the motor 166 operates to drive the chain belt 170. The left and right gear segments 106c may rotate through substantially the same angular displacement (+/−5 degrees), but in opposite rotational directions. Owing to the construction of the door assemblies 106, the rotation of the gear segments 106c causes each respective door assembly 106 to rotate in tandem with the respective gear segment 106c coupled thereto.

The directionality of the motor 166 controls the direction of movement of the door assemblies 106. The motor 166 may be controlled to change directions based upon the states of limit switches 192 and 194 that correspond to the positions (i.e., open and closed) of the door assemblies 106.

For example, the dispenser may include a forward door microswitch 192 and a rear door microswitch 194 to control the rotation direction of the motor 166 to open or close the door assemblies 106. Each of microswitches 192 and 194 may be connected to the controller 136. The door microswitches 192 and 194 may be on the left side of the bottom shell 132 (as shown in FIG. 4a), the right side, or both sides. Each gear segment 106c has a forward pin 196 (FIG. 10) and a rearward pin 198 that extend vertically downward from a bottom side of the gear segment 106c. The forward door microswitch 192 is positioned in the path of an arc swept by the forward pin 196 so that the forward pin 196 will contact and actuate the forward door microswitch 192 during movement of the left gear segment 106c. The forward door microswitch 192 may be positioned such that it will be actuated by the forward pin 196 when the left gear segment 106c rotates to a position corresponding to the door assemblies 106 being in their fully open position. The rearward door microswitch 194 is positioned in the path of the arc swept by the rearward pin 198 so that the rearward pin 198 contacts and actuates the rearward door microswitch 194 during movement of the left gear segment 106. The rear door microswitch 194 may be positioned such that it will be actuated by the rearward pin 198 when the left gear segment 106c rotates to a position corresponding to the door assemblies 106 being in their fully closed position. In one embodiment, the motor 166 moves in a first direction when the forward door microswitch 192 is actuated and moves in a second direction, opposite the first direction, when the rear door microswitch 194 is actuated.

### Warming Compartment

The warming compartment 104 is configured to heat the baby bottle 108a dispensed from the refrigerated compartment 104 using a heating element 138. The warming compartment warms the contents of the bottle 108a to a serving temperature desired by the user. The heating element 138 may be constructed as an electric coil-type heating element plate that is configured to boil water and generate steam to warm the bottle 108a. However, other types of heating elements may be used, such as an infrared heat lamp.

In the embodiment of the dispenser 100 shown in FIGS. 2a and 9, the heating element 138 is configured to generate steam from water supplied from a water reservoir 260 (FIG. 2a) that is fluidly coupled to the dispenser 100. The steam generated from the water is used to warm the filled bottle 108a that has been dispensed from the refrigerated compartment 102 and is positioned above the heating element 138. As shown in FIG. 2a, the bottle 108a is held in a bottle nest 148 that is supported over the heating element 138 by the outer shell 202 and the water reservoir 260.

The bottle nest 148 shown in FIG. 9 has a handle 148a connected to a rim of a partially open receptacle 148b. The receptacle 148b has a base 148c and a sidewall 148d connected to the base 148c. The base 148c and the sidewall 148d have openings therein to permit steam to travel upward from the heating element 138. The rear of the receptacle faces the door assemblies 106 and is open to permit passage of the dispensed bottle 108a into the receptacle 148b and onto its base 148c in an upright or tilted orientation. A portion of the nest handle 148a is constructed to be received in a groove 290 formed between the reservoir 260 and the outer shell 202. When the nest handle 148a is seated in the groove 290, the base 148c of the receptacle 148b is spaced from the heating element 138 such that the bottle 108a received in the receptacle 148b is suspended over the heating element 138 and is in the pathway of steam rising from the heating element 138 when the heating element 138 is operating.

The operation of heating element 138 may be controlled to prevent unwanted operation of the heating element 138 under certain conditions. For example, the dispenser 100 may be configured to not supply power to the heating element 138 if a bottle 108a is not present in the warming compartment or if a bottle of a sufficient weight indicative of a bottle filled with at least a certain amount of fluid is not present in the warming compartment. Also, the dispenser 100 may be configured to not supply power to the heating element 138 if there is not a sufficient quantity of water present in the reservoir 260 to generate steam for heating the bottle 108a.

For example, as shown in FIG. 3, the dispenser 100 may include a bottle pressure switch 144 coupled to a pushrod 146. As shown in FIG. 9, the pushrod extends through an opening in the groove 290. The bottle pressure switch 144 may include a microswitch, such as a 12 VDC microswitch. The bottle pressure switch 144 may be electrically connected as an input to the controller 136. The bottle pressure switch 144 may be configured for on/off control based on a pressure sensed by the bottle pressure switch 144. The bottle pressure switch 144 may be configured to be actuated (closed) by the pushrod 146 that can transmit the weight of a filled bottle (e.g., bottle 108a) dispensed by the dispenser 100. The bottle pressure switch 144 may be configured as a normally open switch such that power to the heater unit 138 is turned off unless the switch 144 is actuated (i.e., closed). The bottle pressure switch 144 may be actuated when the weight of a filled baby bottle (e.g., bottle 108a) of at least a predetermined weight is transmitted to the push rod 146 through contact with the bottle nest 148 that receives the dispensed bottle 108a. Thus, the bottle pressure switch 144 may be configured to permit the heating element 138 to receive power only when a dispensed bottle of a certain filled weight is present in the bottle nest 148 and positioned over the heating element 138. When the handle 148a of the nest 148 is received in the groove 290, the handle 148a will push down on the top of the pushrod 146 to apply pressure to the pressure switch 144. In one embodiment, unless the filled bottle 108a weighs at least a predetermined amount, the pressure switch 144 will not be actuated and the heating unit will remain unpowered.

As noted above, in at least one embodiment the heating element 138 generates steam from water supplied by a water reservoir 260. The water reservoir 260 is constructed to interface with the outer shell 202 and supply water to the heating element 138 as needed to generate steam to warm bottles dispensed from the refrigerated compartment 102.

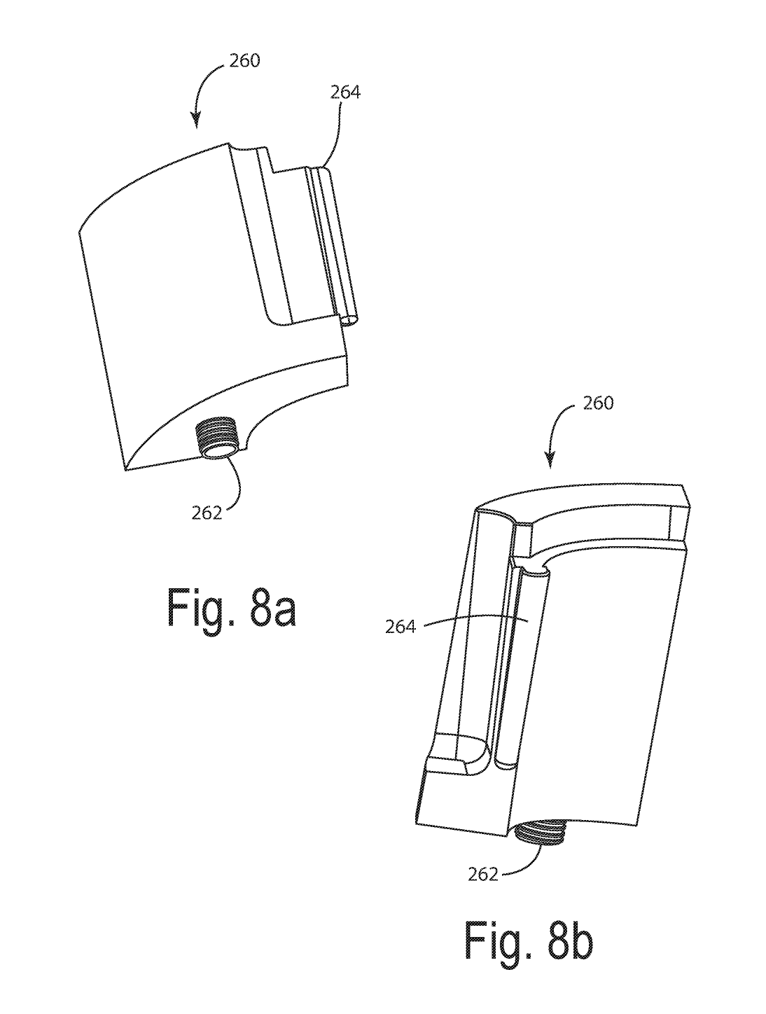

The water reservoir 260 of the dispenser 100 is most clearly shown in FIGS. 8a and 8b. The reservoir 260 is fluidly coupled to the outer shell 202. The reservoir 260 may be removable from the outer shell 202, such as for filling and draining the reservoir 260. The reservoir 260 may be formed from plastic and may be formed of translucent plastic so that the level of water in the reservoir 260 can be viewed by a user. The reservoir 260 may have an opening 262 on its bottom side that can be used to fill and drain the reservoir 260. The reservoir may have a tapered projection 264 that extends along a side that facilitates alignment and seating the reservoir onto the outer shell 202. While only one projection 264 is shown in FIGS. 8a and 8b, it will be appreciated that at least an additional projection may extend from a side of the reservoir 260 opposite projection 264.

FIG. 9 shows an exploded view of the front of the dispenser 100 with the reservoir 260 removed for purposes of illustration. The outer shell 202 has a vertical tapered groove 272a formed therein for sliding engagement with the corresponding tapered projection 264 of the reservoir 260. A reservoir seat 274 is formed in the outer shell 202 to receive and fluidly couple to the reservoir 260. The reservoir seat 274 may be defined by a fluid interface between the reservoir 260 and the outer shell 202. For example, in the embodiment shown in FIG. 9, the reservoir seat 274 has a notch 276 formed therein that aligns at one end with the opening 262 of the reservoir 260 when the reservoir 260 is seated on the reservoir seat 274. The engagement between the projection 264 and the groove 272 facilitates seating of the reservoir 260 onto the seat 274 and alignment of the opening 262 with notch 276. A second tapered groove 272b may be formed in the outer shell 202 opposite tapered groove 272a and may receive a second projection (not shown) like that of projection 264 on a side of the reservoir 260 opposite projection 264.

The notch 276 extends to a channel 278 formed in the outer shell 202 that surrounds the heating element 138 to direct water from reservoir 260 to the heating element 138 so that the water on the heating element 138 can be boiled to generate steam for warming the dispensed bottle 108a located over the heating element 138. Also, a silicone seal 135 (FIG. 3) may be interposed between the heating element 138 and the outer shell 202 to provide a watertight seal therebetween and to further direct water from the channel 278 onto the heating element 138.

Though not shown, a valve may be interposed between the reservoir 260 and the outer shell notch 276 to control the flow of water from the reservoir 260 to the heating element 138. For example, a valve may be configured to dispense water to the heater element 138 based on a level of water standing above the heating element 138 in the channel 278. Specifically, the valve may be constructed as a float valve to maintain the level of water above the heating element 138 at a predetermined level to ensure that water is present to generate steam for warming the dispensed bottle 108a. Such a valve may be integrated with the reservoir 260 or the outer shell 202.

As noted above, the dispenser 100 may be configured to not supply power to the heating element 138 if there is not a sufficient quantity of water present in the reservoir 260 to generate steam for heating the bottle 108a. To effect such control, the dispenser 100 may also include a low water level switch (not shown) that senses the level of water in the reservoir 260 to determine whether or not the water reservoir 260 has a sufficient amount of water for operating the heating element 138. For example, the low water level switch may be constructed in similar manner to the bottle pressure switch 144, described above, but may be constructed to sense the weight of the reservoir 260 instead of the weight of a bottle 108a. Specifically, the low water level switch may include a reservoir pressure microswitch, such as a 12 VDC microswitch, that is electrically connected to the controller 136 and to the supply of electrical power to the heating element 138. A push rod or linkage (not shown) may be routed through the seat 274 (FIG. 9) under the water reservoir 260 to the microswitch. The controller 136 may be configured to not power to the heating element 138 if the weight of the reservoir 260 is insufficient to actuate the low water level switch, which may prevent operating the heating element 138 without sufficient water being present to generate steam for heating.

### Controller

The dispenser 100 may receive power from a supply of power. In one embodiment, the dispenser is powered by a supply of alternating current. Also, the dispenser may include an inverter 134 that receives power from a supply of electrical power (not shown). In one embodiment, the inverter 134 converts alternating current (AC) to direct current (DC). For example, the inverter 134 may convert 110 VAC to 12 VDC. The inverter 134 is electrically connected to and powers the controller 136 that may include a printed circuit board. The controller 136 controls the operation of the dispenser 100, as described in greater detail below.

In one embodiment, a 110 VAC shunt (not shown) from the inverter 134 connects to the heating element 138 through the controller 136 and the controller 136 is connected to at least one bottle pressure switch 144 that controls the flow of power through the shunt to the heater. In one embodiment, the controller 136 includes a relay (not shown) connected to the shunt and to the bottle pressure switch 144. The relay contacts close when the pressure switch 144 is actuated and the relay contacts open when the pressure switch 144 is not actuated.

The controller 136 is constructed to receive a signal to dispense a bottle, which activates the actuation unit 164. If the rear door microswitch 194 is actuated, corresponding to the state of the door assemblies 106 being closed, the controller 136 may operate the motor 166 to rotate the drive gear 168 in the direction to open the door assemblies 106 (i.e., counterclockwise in FIG. 4). However, once the doors rotate a certain amount the forward pin 196 actuates the forward door microswitch 192, whereupon the controller 136 will reverse the direction of the motor 166 and drive gear 168 (i.e., rotate clockwise in FIG. 4) to close the door assemblies 106. Then, when the door assemblies 106 are in their closed positions, the rearward pin 198 will actuate the rear door microswitch 194 to return the controller 136 to the state before receiving the signal, at which time the controller 136 may turn off power to the motor 166.

The controller 136 is configured to control the cooling, heating, and dispensing functions of the dispenser 100. The controller 136 may include a control panel 137 (FIGS. 1 to 3) on the dispenser 100 that includes a display 139 that displays information such as the temperature in the refrigerated compartment as well as the temperature of the contents of the dispensed bottle during and/or after it is heated. For example, the dispenser may include an infrared thermometer that is configured to measure the temperature of the contents of a bottle 108a in the warming compartment 104. An example of such a thermometer is the Caretalk-Digital Talking Baby Thermometer supplied by Caretalk Technology Company, Ltd., Hong Kong. The control panel 137 may also include a keypad 141 that may be used by a user to communicate with the controller 136. The controller 136 may be constructed to receive a wireless signal, such as a radio frequency (RF) signal from a remote device (not shown) to operate the dispenser 100. For example, the controller 136 may be configured to receive a command signal to dispense and heat a bottle. Also, for example, the controller 136 may be configured to receive a signal to set one or more of a heating time for the heater unit 138, a temperature for the refrigerated compartment, and a temperature of the fluid in the heated bottle. Also, the keypad may be used to input the same information to the controller 136 that is otherwise received wirelessly.

Also, the controller 136 may be configured to generate a signal and send the signal to the remote device to alert a user of the remote device of the status of the dispenser 100. The controller 136 may also be configured to output status information to the display 139 of the control panel 137 in addition to, or in place of, the status information transmitted to the remote device. For example, the controller 136 may be configured to generate and transmit a warning signal to the remote device and/or display a message on the display 139 of the control panel 137 if the water level in the reservoir 260 is below a certain level or if there is no bottle in the bottle nest 148 of sufficient weight to turn on the heater unit 138 after a user transmits a signal to dispense a bottle.

Also, the controller 136 may be configured to adjust the heating time of the heater unit 138 based on a sensed weight of a bottle in the bottle nest 148 or based on a fixed timing set by a user. The controller 136 may also be configured to store information about each bottle (e.g., bottle 108) stored in the dispenser 100 based on the position of the bottle in the wire rack assembly 222. For example, a user may set different heating times for different bottles in the dispenser. Thus, a user who may place a 4 oz bottle next to a 6 oz bottle may set the heating time for the 4 oz bottle to be different than for the 6 oz bottle. It will be appreciated that a user may configure the heating times using the keypad 141 of the control panel or using the remote device.

The controller 136 may also be configured to send a completion signal to the remote device of the user to inform the user that the dispensing and warming operations have been completed and that the warmed bottle is ready for use. Such a signal may illuminate a portion of the remote device, vibrate the remote device, or generate an audible tone. Also, the controller 136 may be configured to display a completion message on the display 139 of the control panel 137 and/or generate an audible tone from a speaker in the control panel 137 to indicate that the warmed bottle is ready for use.

The dispenser 100 may be configured to be used manually as a conventional bottle warmer to warm bottles that have not been stored in the refrigerated compartment 102 of the dispenser 100. Such a feature may be useful to warm bottles of children visiting a home in which the dispenser 100 is located.

### Dispenser Workflow

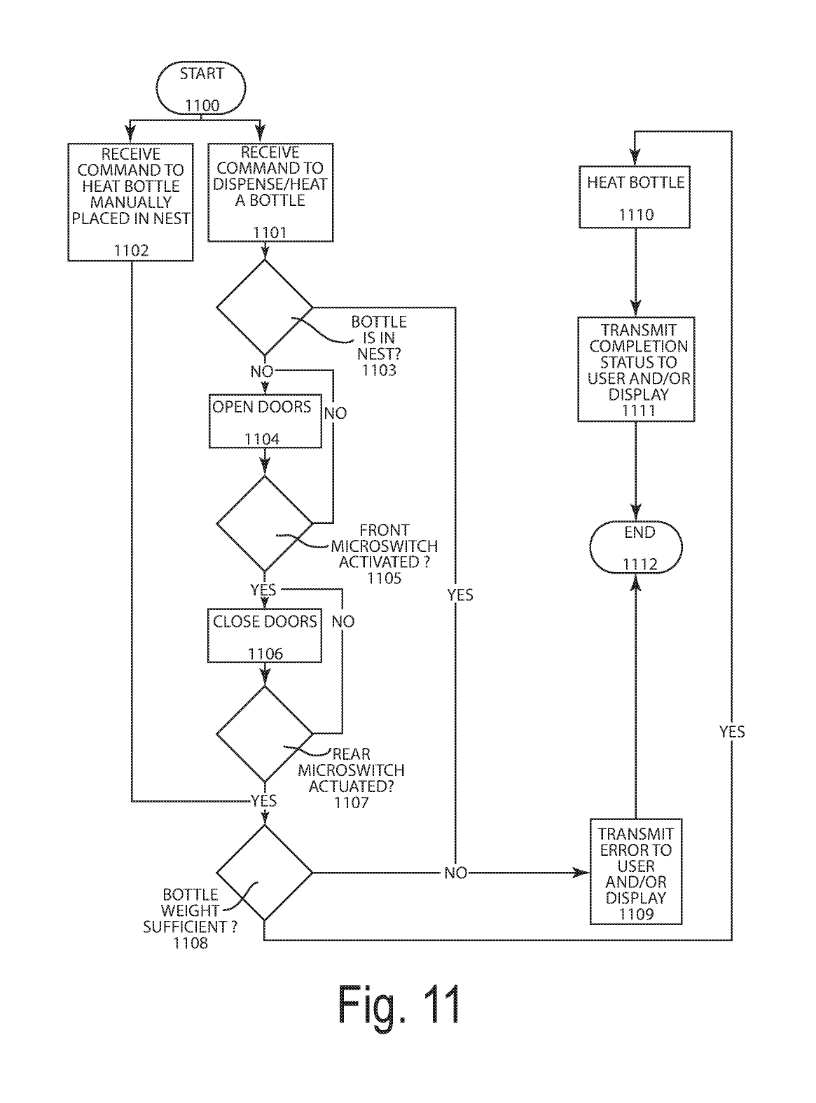

A workflow of the operation of the dispenser will now be described with reference to the flow chart in FIG. 11. At 1100 a user may decide that a warmed baby bottle is needed. At 1101 the controller 136 receives a command to dispense and heat a baby bottle. Alternatively, at 1102, the controller 136 receives a command to only heat a bottle that is manually placed in the bottle nest 148 by the user. At 1103 it is determined whether or not a bottle is in the bottle nest 148 prior to dispensing from the refrigerated compartment 102 to the warming compartment 104. If a bottle is in the bottle nest 148 (YES at 1103) then the workflow proceeds to 1109 at which point an error is transmitted to a user and/or displayed on display 137 of the dispenser 100. If a bottle is not in the bottle nest 148 (NO at 1103), then at 1104 the controller 136 powers the motor 166 to open the door assemblies 106. At 1105 it is determined whether the front microswitch 192 has been actuated. If the front microswitch 192 has not been actuated (NO at 1105), then the door assemblies 106 continue to be opened until the front microswitch 192 is actuated (YES at 1105). When the door assemblies 106 are opened and the front microswitch 192 is actuated, a captured bottle sitting on wire rack assembly 222 will have been dispensed into the bottle nest 148, as described above. The controller 136 will then reverse the direction of the motor 166 to close the doors at 1106. At 1107 it is determined whether the rear microswitch 194 has been actuated. If the rear microswitch 194 has not been actuated (NO at 1107), then the door assemblies 106 continue to be closed until the rear microswitch 194 is actuated (YES at 1107). When the door assemblies 106 are closed and the rear microswitch 194 is actuated, it is determined at 1108 whether or not the weight of the dispensed bottle in the nest 148 is sufficient to turn on the heating element 138. If the weight is not sufficient (NO at 1108), then an error is transmitted to the user's remote device and is displayed on the display 139 of the control panel 137 of the dispenser 100 at 1109. If the weight is sufficient (YES at 1108), then power is transferred to the heating element 138 to heat the dispensed bottle at 1110. After heating the dispensed bottle, a completion signal is transmitted to the user and a completion status is displayed on the display 139 of the control panel 137 of the dispenser 100 at 1111. The workflow ends at 1112 with a heated bottle that can be retrieved from the bottle nest 148 of the dispenser 100.

If the user selects at 1102 to manually heat a bottle that is not dispensed by the dispenser 100, then the workflow moves to 1108 and proceeds to completion in accordance with the remainder of the workflow described above.

There have been described and illustrated herein several embodiments of a baby bottle dispenser and a method of dispensing a baby bottle using a baby bottle dispenser. While particular embodiments of the invention have been described, it is not intended that the invention be limited thereto, as it is intended that the invention be as broad in scope as the art will allow and that the specification be read likewise. Thus, while a particular actuation arrangement has been disclosed, it will be appreciated that other actuation arrangements may be employed as well to dispense a baby bottle from a refrigerated compartment to a warming compartment. For example, while two door assemblies have been shown in one embodiment, it will be appreciated that a dispenser with a single door may be used. Also, while a motorized gear and belt arrangement has been described for moving the door assemblies, it will be appreciated that other door opening arrangements may be used. For example, rather than use a motor to open and close the doors, in at least one other embodiment, the doors may be biased to remain closed until a motorized pusher exerts a force on bottles stored in the refrigerated compartment of the dispenser that overcomes the bias force of the doors. In addition, while a particular type of cooling unit has been described, it will be understood that other types of cooling units can be used. For example, and not by way of limitation, a vapor-compression refrigeration system may be used. Also, while a spring biased pusher assembly is preferred, it will be recognized that a motorized pusher may be used in addition to or in place of a spring biased pusher. It will therefore be appreciated by those skilled in the art that yet other modifications could be made to the provided invention without deviating from its spirit and scope as claimed.

What is claimed is:

1. A baby bottle dispensing apparatus comprising:
a refrigerator for storing a plurality of filled baby bottles;
a heater for heating a selected one of the plurality of filled baby bottles dispensed from said refrigerator;
a conveyor for moving said selected baby bottle from said refrigerator to said heater; and
a housing commonly housing said refrigerator, said heater, and said conveyor.

2. The baby bottle dispensing apparatus of claim 1, further comprising:
a controller for automatically controlling the conveyor in response to a dispensing signal.

3. The baby bottle dispensing apparatus of claim 1, wherein:
the conveyor includes an actuator for selectively opening and closing a door between said refrigerator and said heater.

4. The baby bottle dispensing apparatus of claim 3, wherein:
said door includes a door panel and a projection that extends from said door panel into said refrigerator, and
wherein said door panel and said projection are configured to capture one of said bottles in said refrigerator between said door panel and said projection when said door is in a closed position.

5. The baby bottle dispensing apparatus of claim 4, wherein:
said actuator includes a motor configured to receive an actuation signal and open said door to move said captured bottle out of said refrigerator in response to said actuation signal.

6. The baby bottle dispensing apparatus of claim 5, wherein:
said motor is configured to close said door after receiving a door closure signal.

7. The baby bottle dispensing apparatus of claim 5, wherein:
said motor is configured to close said door after said door opening a predetermined amount.

8. The baby bottle dispensing apparatus of claim 4, wherein:
said conveyor includes a biasing member that urges the bottles stored in said refrigerator against said door.

9. The baby bottle dispensing apparatus of claim 5, wherein:
when said door is in an open position, said projection is positioned to block egress of the bottles out of said refrigerator.

10. The baby bottle dispensing apparatus of claim 1, further comprising:
a thermoelectric cooling unit coupled to said refrigerator.

11. The baby bottle dispensing apparatus of claim 1, wherein:
said heater comprises an electrical resistance heater.

12. The baby bottle dispensing apparatus of claim 11, further comprising:
a bottle pressure switch configured to control said heater based on the presence of a filled bottle over said heater.

13. The baby bottle dispensing apparatus of claim 12, wherein:
said bottle pressure switch is configured to turn on said heater when a filled bottle of at least a predetermined weight is present over said heater.

14. The baby bottle dispensing apparatus of claim 12, wherein:
said bottle pressure switch is configured to turn off said heater when a filled bottle of at least a predetermined weight is not present over said heater.

15. The baby bottle dispensing apparatus of claim 2, wherein:
said controller is configured to control the temperature in said refrigerator.

16. The baby bottle dispensing apparatus of claim 11, wherein:
said controller is configured to actuate the heater in response to the presence of a filled bottle over said heater.

17. The baby bottle dispensing apparatus of claim 16, wherein:
said controller is configured to control a duration of operation of said heater.

18. The baby bottle dispensing apparatus of claim 1, wherein:
said refrigerator defines a refrigerated compartment that is substantially enclosed, and
said heater is located in a warming compartment defined by a portion of the housing, and wherein the warming compartment is substantially open.

19. A method of preparing a filled baby bottle for use comprising:
providing a baby bottle dispensing apparatus comprising:
a refrigerator for storing a plurality of filled baby bottles,
a heater for heating a selected one of the plurality of filled baby bottles dispensed from said refrigerator,
a conveyor for moving said selected baby bottle from said refrigerator to said heater, and
a housing commonly housing said refrigerator, said heater, and said conveyor;
receiving a signal to dispense a bottle from said dispensing apparatus;
responsive to said signal, actuating said conveyor to move a baby bottle from said refrigerator to said heater; and
heating said dispensed bottle with said heater.

20. The method according to claim 19, wherein:
said actuating said conveyor includes opening at least one door between said refrigerator and said heater, moving said dispensed bottle through said opened door, and closing said door.

21. The method according to claim 19, wherein:
said receiving a signal includes wirelessly receiving a command to dispense a bottle from said dispensing apparatus.
